(19) United States
(12) Patent Application Publication
(10) Pub. No.: US 2024/0391296 A1
(43) Pub. Date: Nov. 28, 2024

(54) Induction Heating Device and Thermal Management System for Vehicle Comprising Same

(71) Applicant: Illinois Tool Works Inc., Glenview, IL (US)

(72) Inventors: Po HU, Shanghai (CN); Feng LIU, Shanghai (CN)

(21) Appl. No.: 18/668,964

(22) Filed: May 20, 2024

(30) Foreign Application Priority Data
May 22, 2023 (CN) 202310577041.6

(51) Int. Cl. B60H 1/22

(52) U.S. Cl. CPC B60H 1/2215

(57) ABSTRACT

The present disclosure provides an induction heating device having an isolation housing, an induction coil, and a heater. The isolation housing defines a fluid path and has a fluid inlet and a fluid outlet connected with the fluid path. The induction coil is wound around the outer surface of the isolation housing. The heater is arranged in the fluid path of the isolation housing and is configured to generate heat in response to an induction current applied to the induction coil. The heater is configured to heat a fluid flowing through the fluid path. The isolation housing is curved in shape and comprises at least two straight sections and at least one curved section. The heater is configured to heat the fluid in the at least two straight sections. The present disclosure further discloses a thermal management system for a vehicle having the induction heating device as described above.

### RELATED APPLICATION

The present application claims the benefit of Chinese Patent Application No. 202310577041.6, filed May 22, 2023, each titled “Induction Heating Device and Thermal Management System for Vehicle Comprising Same,” the contents of which are hereby incorporated by reference.

### TECHNICAL FIELD

Embodiments of the present disclosure generally relate to an induction heating device for a thermal management system for a vehicle, and a thermal management system for a vehicle comprising the induction heating device.

### BACKGROUND

A thermal management system for a vehicle may be used for preheating components (such as a battery system) in the vehicle, heating air in a cabin, or the like. For example, for an electric vehicle that uses a battery as a power source, since the battery can only achieve its optimal performance at around 20° C. to 40° C., when the ambient temperature is low, it is necessary to heat the battery using a thermal management system to enable the battery to achieve its optimal performance, so as to improve the endurance of the vehicle.

### SUMMARY

The present disclosure relates generally to an induction heating device and a thermal management system, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 is a block diagram of a thermal management system for a vehicle according to an example of the present disclosure.

FIG. 2A is a perspective view of an induction heating device in FIG. 1.

FIG. 2B is a partial sectional view of the induction heating device in FIG. 2A.

FIG. 3A is a front view of the induction heating device in FIG. 2A.

FIG. 3B is a sectional view taken along line A-A in FIG. 3A.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Embodiments of the present disclosure provide an induction heating device and a thermal management system for a vehicle comprising the induction heating device. According to the present disclosure, the structural arrangement of an induction heating device enables an improved efficiency of heating a thermal management fluid without increasing the space or volume occupied by the induction heating device.

According to a first aspect of the present disclosure, the present disclosure provides an induction heating device, comprising an isolation housing, an induction coil, and a heater. The isolation housing defines a fluid path and has a fluid inlet and a fluid outlet connected with the fluid path. The induction coil is wound around the outer surface of the isolation housing. The heater is arranged in the fluid path of the isolation housing and is configured to generate heat in response to an induction current applied to the induction coil. The heater is configured to heat a fluid flowing through the fluid path. The isolation housing is curved in shape and comprises at least two straight sections and at least one curved section. The heater is configured to heat at least the fluid in the at least two straight sections.

According to the induction heating device of the first aspect, the induction coil comprises a thick wire wound around the at least two straight sections of the isolation housing in the form of a single layer winding coil, the two adjacent turns of the winding coil being spaced apart from each other.

According to the induction heating device of the first aspect, the heater comprises at least two heating elements. The at least two heating elements are respectively arranged in the at least two straight sections of the isolation housing and extend along the corresponding straight sections.

According to the induction heating device of the first aspect, each of the at least two heating elements is tubular. An outer surface of each of the heating elements is spaced apart from the inner wall of the isolation housing to enable the fluid flowing through the fluid path to contact both an inner surface and the outer surface of each of the at least two heating elements.

According to the induction heating device of the first aspect, the at least two heating elements are held in the fluid path of the isolation housing by support members.

According to the induction heating device of the first aspect, a plurality of spoiler fins are provided on the outer surface and the inner surface of each of the at least two heating elements.

According to the induction heating device of the first aspect, the induction coil is a flat wire.

According to the induction heating device of the first aspect, the isolation housing is U-shaped, the fluid inlet and the fluid outlet being provided on the same side of the isolation housing.

According to the induction heating device of the first aspect, the isolation housing is in the form of a round tube.

According to a second aspect of the present disclosure, the present disclosure provides a thermal management system for a vehicle, comprising the induction heating device according to the first aspect. The isolation housing is connected in a circulation line of the thermal management system by means of the fluid inlet and the fluid outlet thereof.

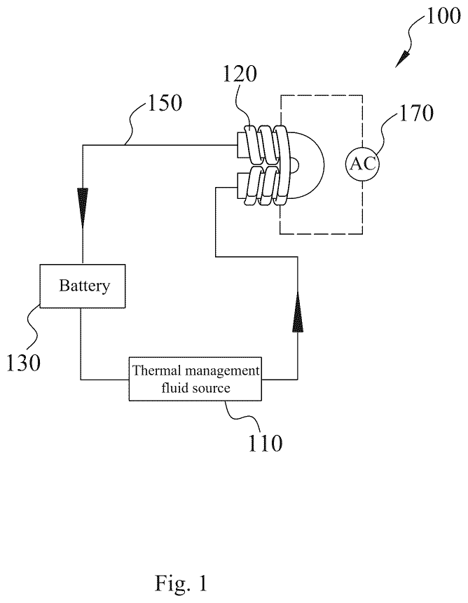

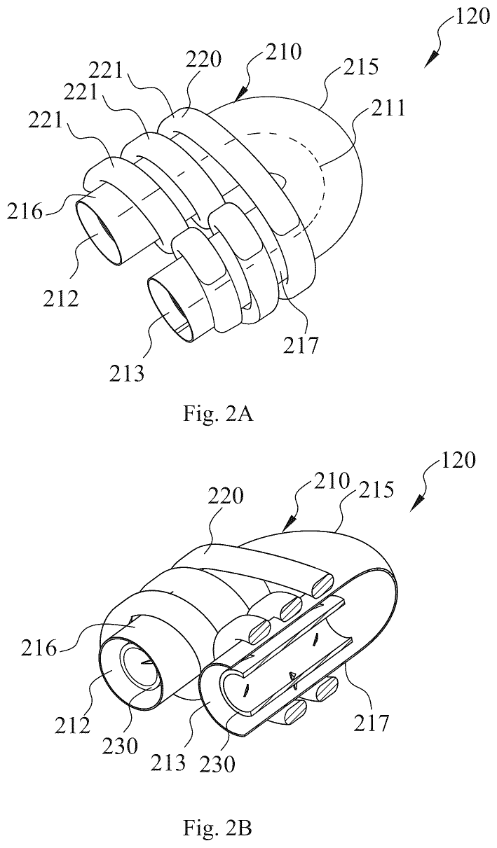

FIG. 1 is a block diagram of a thermal management system for a vehicle according to an example of the present disclosure. As shown in FIG. 1, the thermal management system 100 for a vehicle comprises a thermal management fluid source 110 for supplying a thermal management fluid (such as water), an induction heating device 120 for heating the thermal management fluid, and a to-be-heated part in the vehicle, such as a battery 130. The thermal management fluid source 110, the induction heating device 120 and the battery 130 are connected in sequence by means of a circulation line 150, so as to form a thermal management fluid circulation. The induction heating device 120 can heat the thermal management fluid before the thermal management fluid is delivered to the battery 130, thereby heating the battery 130 by the heated thermal management fluid, and enabling the battery 130 to achieve its optimal performance at a desired temperature. The induction heating device 120 is connected with a control power supply 170, and the control power supply 170 applies to the induction heating device 120 a medium-high frequency alternating current, which generates an alternating magnetic field in an induction coil 220 (see FIG. 2A) of the induction heating device 120, so that a heater 230 (see FIG. 2A) of the induction heating device 120 generates heat.

FIG. 2A and FIG. 2B show an overall structure of the induction heating device 120 in FIG. 1. FIG. 2A is a perspective view of the induction heating device in FIG. 1, and FIG. 2B is a partial sectional view of the induction heating device in FIG. 2A. As shown in FIG. 2A and FIG. 2B, the induction heating device 120 comprises an isolation housing 210, the induction coil 220 wound around the outer surface of the isolation housing 210, and the heater 230 arranged in the isolation housing 210.

The isolation housing 210 has a fluid inlet 212 and a fluid outlet 213. The isolation housing 210 defines a fluid path 211, and the fluid path 211 is connected with the fluid inlet 212 and the fluid outlet 213, so that the thermal management fluid enters the isolation housing 210 from the fluid inlet 212, and flows through the fluid path 211 and out of the fluid outlet 213.

As shown in FIG. 2B, the heater 230 is arranged in the fluid path 211 of the isolation housing 210. The heater 230 can generate heat in response to an induction current applied to the induction coil 220 to heat the thermal management fluid flowing through the fluid path 211. The heater 230 is made of a magnetic material (a magnetic dielectric material, such as a magnetizer for different frequencies formed by mixing and pressing iron, cobalt, nickel, etc. and an insulating bonding material), which is also called a magnetizer. When the induction coil 220 is energized, the heater 230 generates heat due to magnetic field induction, so that the heater 230 itself becomes a heat source. Thus, the heater 230 can heat the thermal management fluid in contact with it by exchanging heat with the thermal management fluid.

As shown in FIG. 2A, the isolation housing 210 is in the form of a round tube and is U-shaped as a whole, and comprises one curved section 215 and two straight sections 216, 217. The two straight sections 216, 217 are respectively connected with two ends of the curved section 215, thereby forming a substantially U-shaped shape. The fluid inlet 212 and the fluid outlet 213 are provided on the same side of the isolation housing 210, thereby facilitating the connection and assembly of the isolation housing 210 and external components.

The isolation housing 210 is made of a plastic material, which can not only electrically isolate the induction coil 220 from the metal heater 230 to avoid a short circuit caused by contact between the two, but can also insulate the thermal management fluid in the fluid path 211 to avoid heat loss.

As shown in FIG. 2A and FIG. 2B, the induction coil 220 is formed of a flat thick wire wound around the straight sections 216, 217 of the isolation housing 210 in the form of a single layer winding coil 221, with the two adjacent turns of the winding coil 221 being spaced apart from each other. No induction coil 220 is wound around the curved section 215 of the isolation housing 210, so that it is easier for the thick wire forming the induction coil 220 to be wound around the isolation housing 210. According to the present disclosure, the on-resistance of the induction coil can be reduced by using the thick wire to form the induction coil, resulting in less power loss of the induction coil. Furthermore, by spacing the two adjacent turns of the winding coil 221 apart from each other, electromagnetic interference between the two adjacent turns of the winding coil 221 can be reduced. Using the flat wire instead of a round wire to form the induction coil 220 can increase the contact area between the induction coil 220 and the isolation housing 210 under the same cross-sectional area, thereby increasing the effective current and further reducing the volume of the induction heating device 120.

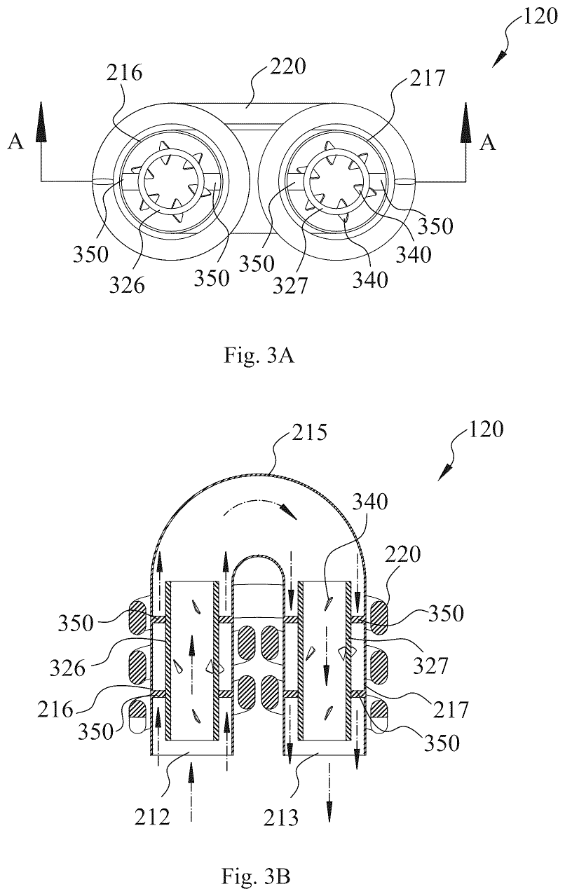

FIG. 3A and FIG. 3B show a specific structure of the induction heating device 120 in FIG. 2A. FIG. 3A is a front view of the induction heating device 120, and FIG. 3B is a sectional view taken along line A-A in FIG. 3A. As shown in FIG. 3A and FIG. 3B, the heater 230 of the induction heating device 120 comprises two separate heating elements 326, 327. The two heating elements 326, 327 are respectively arranged in the two straight sections 216, 217 of the isolation housing 210 and extend along the corresponding straight sections 216, 217. No heating element is arranged in the curved section 215 of the isolation housing 210, so that the heating element will not be deformed due to uneven heating.

Still as shown in FIG. 3A and FIG. 3B, each of the heating elements 326, 327 is tubular and is supported by a support member 350 in the corresponding straight section 216, 217 of the isolation housing 210. The heating elements 326, 327 are suspended and supported in the straight sections 216, 217 of the isolation housing 210, such that the outer surfaces of the heating elements 326, 327 are spaced from the inner wall of the straight sections 216, 217 of the isolation housing 210 by a distance. Therefore, not only is a fluid path formed inside the tubular heating element 326, 327, but a fluid path is also formed between the outside of the tubular heating element 326, 327 and the isolation housing 210. In this way, the thermal management fluid flowing through the fluid path 211 can contact both the inner surface and the outer surface of the heating elements 326, 327. Thus, the tubular heating element 326, 327 can heat the thermal management fluid by means of both surfaces (the inner and outer surfaces) thereof. In the flow path of the same length, the fluid heated by both surfaces of the heating element 326, 327 is heated more efficiently than a fluid heated by only one surface of the heating element.

Still as shown in FIG. 3A and FIG. 3B, in the example shown in the figures, the support member 350 is in a shape of a rib, two ends of which are respectively connected with the outer surface of the heating element 326/327 and the inner wall of the straight section 216/217 of the isolation housing 210. Four support members 350 are provided in pairs on opposite sides of the heating element 326/327, and two support members 350 on the same side are spaced by a distance along the length direction of the heating element 326/327, such that the heating element 326/327 is suspended and supported stably by the four support members 350 in the straight section 216/217 of the isolation housing 210.

Still as shown in FIG. 3A and FIG. 3B, a plurality of spoiler fins 340 are provided on the outer surface and the inner surface of the tubular heating elements 326/327. The spoiler fins 340 extend outward from the outer surface of the tubular heating elements 326/327, or extend inward from the inner surface thereof, so that the spoiler fins 340 are arranged in the fluid paths inside and outside the tubular heating elements 326/327, thereby creating a certain resistance to the flow of the fluid, so as to increase the time for heat exchange between the heating elements 326/327 and the thermal management fluid.

The arrows in FIG. 3B show the flow of the thermal management fluid in the induction heating device 120. As shown in FIG. 3B, the thermal management fluid flows into the fluid inlet 212 of the isolation housing 210, through the straight section 216, the curved section 215 and the straight section 217 of the isolation housing 210 in sequence and out of the fluid outlet 213 of the isolation housing 210.

In the straight section 216, the thermal management fluid contacts the inner surface and the outer surface of the heating element 326. The heating element 326 generates heat under the action of the induction coil 220, which is mainly concentrated on the inner surface and the outer surface of the heating element 326 due to the skin-effect. Therefore, the heating element 326 can exchange heat with the thermal management fluid in contact with the inner surface and outer surface thereof, thereby heating the thermal management fluid. Furthermore, in the straight section 216, the thermal management fluid collides with the spoiler fins 340 on the inner surface and the outer surface of the heating element 326, causing a certain resistance to the flow of the thermal management fluid. As a result, the time for heat exchange between the thermal management fluid and the inner surface and the outer surface of the heating element 326 is increased to a certain extent.

In the curved section 215, the thermal management fluid in the curved section 215 is not heated by the heating elements, since there is no heating element arranged in the curved section 215. When the thermal management fluid flows from the straight section 216 to the straight section 217 through the curved section 215, the flow rate of the thermal management fluid in the entire flow path 211 of the isolation housing 210 is slowed down due to the diversion of the thermal management fluid, which also increases the time for heat exchange between the thermal management fluid and the inner surface and the outer surface of the heating element 326 to a certain extent.

In the straight section 217, the heating element 326 contacts the inner surface and the outer surface of the heating element 327, and is thus further heated. Furthermore, the thermal management fluid collides with the spoiler fins 340 on the inner surface and the outer surface of the heating element 327 in the straight section 217, causing a certain resistance to the flow of the thermal management fluid. As a result, the time for heat exchange between the thermal management fluid and the inner surface and the outer surface of the heating element 327 is increased to a certain extent.

It should be noted that although in the example shown in the figures, the isolation housing is shaped in a U-shape, in other examples, the isolation housing may also be shaped in other shapes, as long as the isolation housing is curved in shape and comprises at least two straight sections and at least one curved section.

According to the present disclosure, providing the curved isolation housing for the induction heating device enables an improved efficiency of heating the thermal management fluid with a simple structure and without increasing the space or volume occupied by the induction heating device. This is because, on the one hand, the curved shape lengthening the flow path in the isolation housing increases the time for heat exchange between the thermal management fluid and the heater, on the other hand, the curved shape slowing down the flow rate of the thermal management fluid in the isolation housing increases the time for heat exchange between the thermal management fluid and the heater.

In addition, according to the present disclosure, enabling the thermal management fluid to contact both the inner surface and the outer surface of the tubular heating element increases the heating area of the heating element, thereby also improving the efficiency of heating the thermal management fluid.

Although the present disclosure is described in conjunction with the examples of examples outlined above, various alternatives, modifications, variations, improvements, and/or substantial equivalents that are known or current or to be anticipated before long may be obvious to those of at least ordinary skill in the art. Furthermore, the technical effects and/or technical problems described in this description are exemplary rather than limiting. Therefore, the disclosure in this description may be used to solve other technical problems and have other technical effects and/or may solve other technical problems. Accordingly, the examples of the examples of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

What is claimed is:

1. An induction heating device, comprising:
an isolation housing defining a fluid path and having a fluid inlet and a fluid outlet connected with the fluid path;
an induction coil wound around an outer surface of the isolation housing; and
a heater arranged in the fluid path of the isolation housing and configured to generate heat in response to an induction current applied to the induction coil, wherein the heater is configured to heat a fluid flowing through the fluid path;
wherein the isolation housing is curved in shape and comprises at least two straight sections and at least one curved section, the heater being configured to heat the fluid in the at least two straight sections.

2. The induction heating device according to claim 1, wherein
the induction coil comprises a thick wire wound around the at least two straight sections of the isolation housing in a form of a single layer winding coil, the two adjacent turns of the winding coil being spaced apart from each other.

3. The induction heating device according to claim 2, wherein
the heater comprises at least two heating elements respectively arranged in the at least two straight sections of the isolation housing and extending along the corresponding straight sections.

4. The induction heating device according to claim 3, wherein
each of the at least two heating elements is tubular, wherein an outer surface of each of the heating elements is spaced apart from the inner wall of the isolation housing to enable the fluid flowing through the fluid path to contact both an inner surface and the outer surface of each of the at least two heating elements.

5. The induction heating device according to claim 4, wherein
the at least two heating elements are held in the fluid path of the isolation housing by support members.

6. The induction heating device according to claim 4, further comprising:
a plurality of spoiler fins provided on the inner surface and the outer surface of each of the at least two heating elements.

7. The induction heating device according to claim 2, wherein
the induction coil is a flat wire.

8. The induction heating device according to claim 1, wherein
the isolation housing is U-shaped, the fluid inlet and the fluid outlet being provided on the same side of the isolation housing.

9. The induction heating device according to claim 1, wherein
the isolation housing is in the form of a round tube.

10. A thermal management system for a vehicle, comprising:
the induction heating device according to claim 1, wherein the isolation housing is connected in a circulation line of the thermal management system via the fluid inlet and the fluid outlet thereof.
